(19) United States
(12) Patent Application Publication
(10) Pub. No.: US 2011/0126722 A1
(43) Pub. Date: Jun. 2, 2011

(54) Food Cutting Device

(76) Inventor: Nermina Krneta, Des Plaines, IL (US)

(21) Appl. No.: 12/952,307

(22) Filed: Nov. 23, 2010

Related U.S. Application Data
(60) Provisional application No. 61/265,164, filed on Nov. 30, 2009.

(51) Int. Cl. A47J 43/00

(52) U.S. Cl. 99/538

(57) ABSTRACT

A food cutting device comprising an elongated body having a pointed tip at a first end, a thread attached to the body and having a beginning proximate the first end and terminating a distance from the first end, and a cutting edge attached to the body proximate the termination of the thread, is disclosed. In an embodiment, the disclosed cutting device comprises an elongated metal rod body having a first end and a second end, the first end of the metal rod body having a point, a metal thread beginning proximate the first end and extending in a winding fashion a distance along the rod body toward the second end before terminating at a point on the body, a looped cutting blade attached to the body proximate the termination point of the metal thread, and a handle proximate the second end of the body comprised of a bend in the body such that the handle facilitates rotation of the device about an axis.

### RELATED APPLICATION

The present application claims the Nov. 30, 2009, filing date of U.S. Provisional application No. 61/265,164, titled “Food Cutting Device,” and incorporates the same herein by reference.

### TECHNICAL FIELD OF THE INVENTION

The present device relates to food cutting devices. Particularly, the present device relates to a cutting instrument which may core foods, such as potatoes, apples, and the like, and make curly pieces of the removed portion of the food.

### BACKGROUND OF THE INVENTION

There are almost as many different food cutting devices on the market as there are food to be cut. From slicing, dicing, chopping, coring, peeling, shredding, and just about every other way a person could conceive of to cut a food product, such as a fruit or vegetable, devices have been invented to do more in either a faster or simpler manner. With these “improved” devices, the number of parts, moving and non-moving alike, have increased to the point where assembly, disassembly and cleaning take more time than the actual cutting. Further, the cost of such cutting appliances can be prohibitive for some.

The present invention solves these and other problems of prior art cutting devices. The present cutting device is simple in design, manufacture and use, and can be readily cleaned after use.

### SUMMARY OF THE INVENTION

There is disclosed herein an improved cutting device which avoids the disadvantages of prior devices while affording additional structural and operating advantages.

Generally speaking, the present food cutting device comprises an elongated body having a pointed tip at a first end, a thread attached to the body and having a beginning proximate the first end and terminating a distance from the first end, and a cutting edge attached to the body proximate the termination of the thread.

In an embodiment, the cutting device comprises an elongated metal rod body having a first end and a second end, the first end of the metal rod body having a point, a metal thread beginning proximate the first end and extending in a winding fashion a distance along the rod body toward the second end before terminating at a point on the body, a looped cutting blade attached to the body proximate the termination point of the metal thread, and a handle proximate the second end of the body comprised of a bend in the body such that the handle facilitates rotation of the device about an axis.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one embodiment of the present invention; and

FIG. 2 is a close-up view of the tip of one embodiment of the present invention.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

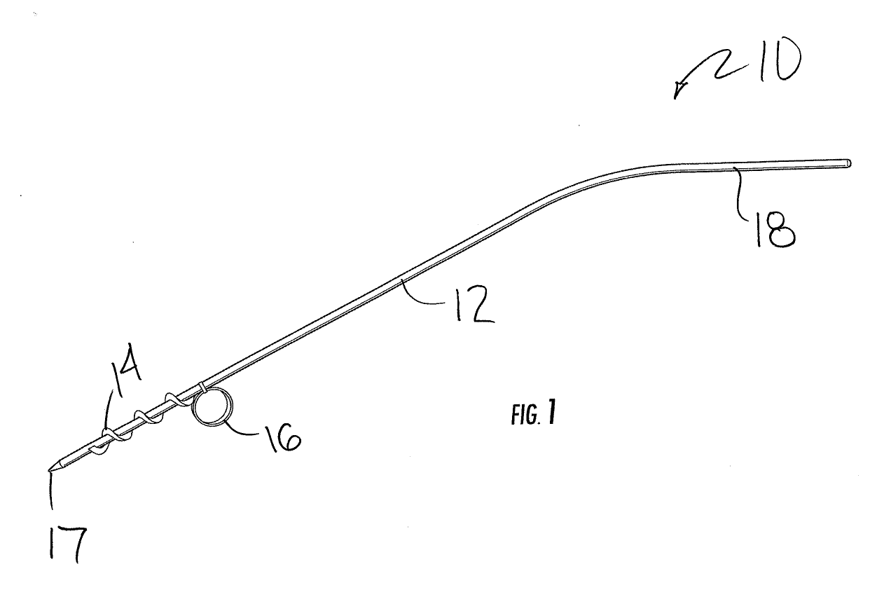

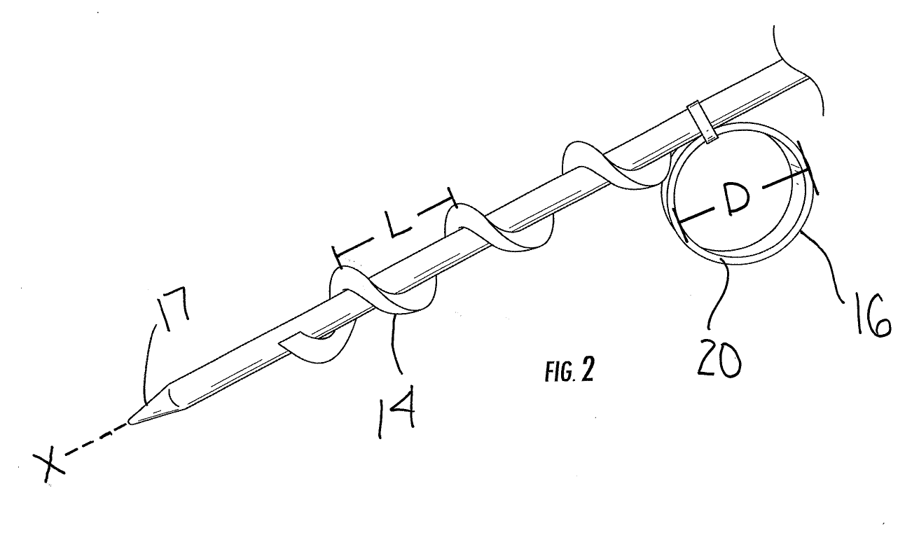

Referring to FIGS. 1-2, there is illustrated a food cutting device, generally designated by the numeral 10. The cutter 10 has a body 12, a thread 14 and a cutting blade 16.

The body 12 is preferably a long, narrow stainless steel rod with a point 17 at one end and a handle 18 at the opposite end. The handle 18 is formed by a bend of approximately 20 to 40 degrees in the body 12 of the device 10. The length of the body 12 is preferably in the range of six (15.2 cm) to 15 inches (38.1 cm), with 10 inches (25.4 cm) being the most preferred length. The handle 18 begins, i.e., the bend occurs at about 3 inches (7.6 cm) from the second end of the body 12. The purpose of the bend is to offset the handle 18 to make turning of the body 12 about a longitudinal axis (x) easier.

The thread 14 of the device 10 begins proximate the point 17 of the body 12, within about one inch (2.54 cm) and most preferably within about ⅝ inch (1.6 cm) of the point. The thread 14 then uniformly coils about the body toward the second end of the body 12. Three or four complete and continuous loops of the thread 14 are preferred with a ¼-inch to ½-inch loop length (L), most preferably about ⅜-inch loop length (L).

At the terminal point of the thread 14, a cutting blade 16 is positioned on the body 12. The cutting blade 16 is preferably cylindrical with a sharp edge 20 at a front of the blade 16. The diameter (D) of the cutting blade 16 is approximately equal to the loop length (L) of the thread. The cylindrical blade 16 is attached to the body 12 such that the axis of the cylinder is substantially parallel to the inclination of the thread 14, though a fairly substantial variation of this alignment may still operate with some diminished effect. This relationship is explained in further detail below.

In use, the point of the body 12 is inserted within a food (not shown), such as a potato for example, until the thread 14 reaches the surface of the food. Then, with the potato held in one hand and the handle 18 of the device 10 in the other, a slight force may be applied as the potato is turned in a direction which moves the cutting blade 16 toward and eventually into the potato. Alternatively, the handle 18 may be turned, but this approach is less favored.

The length (L) of the thread loops determine how quickly the blade 16—or perhaps more accurately, the potato—is moved forward. With each complete turn, the device 10 is advanced a distance (L). Once the blade 16 reaches the food, it begins to cut an opening having a radius equal to the blade 16 diameter (D). If (L) is less than the diameter (D) of the cutting blade 16, then the resulting string of food material cut from the food item will be thinner. If (L) is greater than the diameter (D) of the cutting blade 16, then the resulting hole in the food will be a spiraling burrow and the resulting food string may be difficult to remove. Preferably, L will be slightly greater than or approximately equal to D.

At any point during the cutting action, rotation of the food or the device 10 may be reversed to withdraw the cutting device 10 from the food. If the cutting action continues, eventually the device 10 will begin to project from the food at a point opposite to the point of entry.

The resulting spiraling food material removed can be used for decoration, garnishing, or as a novelty food item. The cut potato, for example, may be sliced to create ring-like chips for cooking, or the entire potato may be cooked and stuffed with other ingredients to create a delicious meal or snack.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A food cutting device comprising:
a body comprising:
an insertion end;
a threaded portion proximate the insertion end; and
a cutting blade extending from the body;
a handle portion attached to the body distal to the insertion end.

2. The food cutting device of claim 1, wherein the threaded portion extends from the body.

3. The food cutting device of claim 1, wherein the body is rod-shaped.

4. The food cutting device of claim 1, wherein the cutting blade comprises a ring having at least one cutting edge.

5. The food cutting device of claim 1, wherein the handle is integral to the body.

6. The food cutting device of claim 3, wherein the handle comprises an extension of the rod-shaped body.

7. A food cutting device comprising:
an elongated body having a pointed tip at a first end;
a thread attached to the body and having a beginning proximate the first end and terminating a distance from the first end;
a cutting edge attached to the body proximate the termination of the thread.

8. The cutting device of claim 7, wherein the elongated body comprises a metal rod.

9. The cutting device of claim 7, further comprising a handle.

10. The cutting device of claim 9, wherein the handle comprises a non-axial portion of the elongated body.

11. The cutting device of claim 10, wherein the non-axial portion of the elongated body is formed by a bend in the body.

12. The cutting device of claim 7, wherein the cutting edge comprises a cylindrical blade.

13. The cutting device of claim 7, wherein the cutting edge comprises a looped blade.

14. A cutting device comprising:
an elongated metal rod body having a first end and a second end, the first end of the metal rod body having a point;
a metal thread beginning proximate the first end and extending in a winding fashion a distance along the rod body toward the second end before terminating at a point on the body;
a looped cutting blade attached to the body proximate the termination point of the metal thread; and
a handle proximate the second end of the body comprised of a bend in the body such that the handle facilitates rotation of either an impaled food about the body or the device about an axis.
